(19) United States
(12) Patent Application Publication
(10) Pub. No.: US 2020/0077606 A1
(43) Pub. Date: Mar. 12, 2020

(54) SELF-WATERING PLANTER

(71) Applicant: ATT Southern Inc., Camp Hill, PA (US)

(72) Inventors: Chun Wai HUNG, Dillsburg, PA (US); Amy BRINCKERHOFF, Marietta, GA (US)

(21) Appl. No.: 16/128,021

(22) Filed: Sep. 11, 2018

(51) Int. Cl. A01G 27/06; A01G 9/02

(52) U.S. Cl. CPC A01G 27/06; A01G 9/02

(57) ABSTRACT

A self-watering planter comprises an outer shell, an inner shell and a water delivery device having a valve element. The outer shell is defined by a bottom surface, a body section and a top opening providing access to an interior. The inner shell is defined by a bottom surface, a body section and a top opening providing access to an interior. The inner shell is sized to be smaller than the interior of the outer shell such that when the inner shell is disposed within the interior of the outer shell, a hollow area is formed between the inner shell and the outer shell for retaining water. An opening is formed through a rim of the planter to provide access to the hollow area for water to be received and stored, and water is metered into the interior of the inner shell by the valve element.

### TECHNICAL FIELD

The present disclosure relates generally to planters, and more specifically to a self-watering planter having a moisture retention feature.

### BACKGROUND

Traditional planters typically include two components, a main pot into which plants and soil are disposed and a separate saucer that is either positioned beneath the bottom of the main pot or attached to the bottom of the main pot. The saucer is wider than the main pot and is attached to the bottom of the main pot, but has a height that is smaller than the main pot. In such traditional arrangements, the growth in the planter is watered from the top, saturating the top of the soil. For some plants and soils, this may encourage insects and mold growth.

While water can be collected in the saucer, to accomplish this, water must be directed through a narrow space between the main pot. Moreover, as the saucer is not very high, it cannot store the water for extended periods of time, thereby requiring frequent watering. Further, in these arrangements, the saucer is open at the top and can attract insects and lead to mold growth as the water stands. Because as there is no closing aspect, water can be jostled out.

What is needed is a planter that will store water for extended periods of time, but without saturating the surface of soil.

### SUMMARY

In one exemplary arrangement, a self-watering planter comprises an outer shell, an inner shell and a water delivery device having a valve element. The outer shell is defined by a bottom surface, a body section and a top opening providing access to an interior. The inner shell is defined by a bottom surface, a body section and a top opening providing access to an interior. The inner shell is sized to be smaller than the interior of the outer shell such that when the inner shell is disposed within the interior of the outer shell, a hollow area is formed between the inner shell and the outer shell for retaining water. An opening is formed through a rim of the planter to provide access to the hollow area for water to be received and stored, and water is metered into the interior of the inner shell by the valve element.

### BRIEF DESCRIPTION OF THE DRAWINGS

Exemplary embodiments of the present disclosure will now be described in greater detail with reference to the attached figures, in which:

FIG. 1 is an exploded view of a self-watering planter in accordance with a first exemplary arrangement;

FIG. 2 is an elevational side view of the self-watering planter, as assembled, of FIG. 1;

FIG. 3 is a cross-sectional view of the self-watering planter of FIG. 1, taken along line 3-3 of FIG. 2;

FIG. 4 is a perspective view of the self-watering planter of FIG. 1, as assembled;

FIG. 5 is a top perspective view of the self-watering planter of FIG. 1;

FIG. 6 is a bottom perspective view of the self-watering planter of FIG. 1;

FIG. 7 is a top plan view of the assembled self-watering planter of FIG. 1;

FIG. 8 is a bottom plan view of the assembled self-watering planter of 1;

FIG. 9A is a top perspective view of an outer planter shell;

FIG. 9B is a bottom perspective view of the outer planter shell of FIG. 9A;

FIG. 10A is a top perspective view of an inner planter shell;

FIG. 10B is a bottom perspective view of the inner planter shell of FIG. 10A;

FIG. 11A is a top perspective view of a valve body;

FIG. 11B is a bottom perspective view of the valve body of FIG. 11A;

FIG. 11C is a side elevational view of the valve body of FIG. 11A;

FIG. 12A is an enlarged view of area 12A in FIG. 3.

FIG. 12B is an enlarged view of area 12B in FIG. 3.

### DETAILED DESCRIPTION

Referring now to the discussion that follows and also to the drawings, illustrative approaches to the disclosed assemblies and methods are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

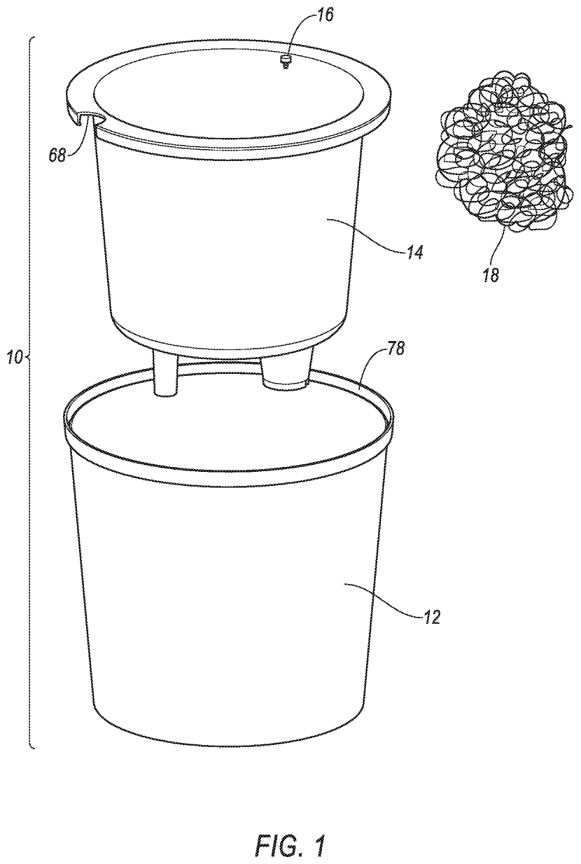

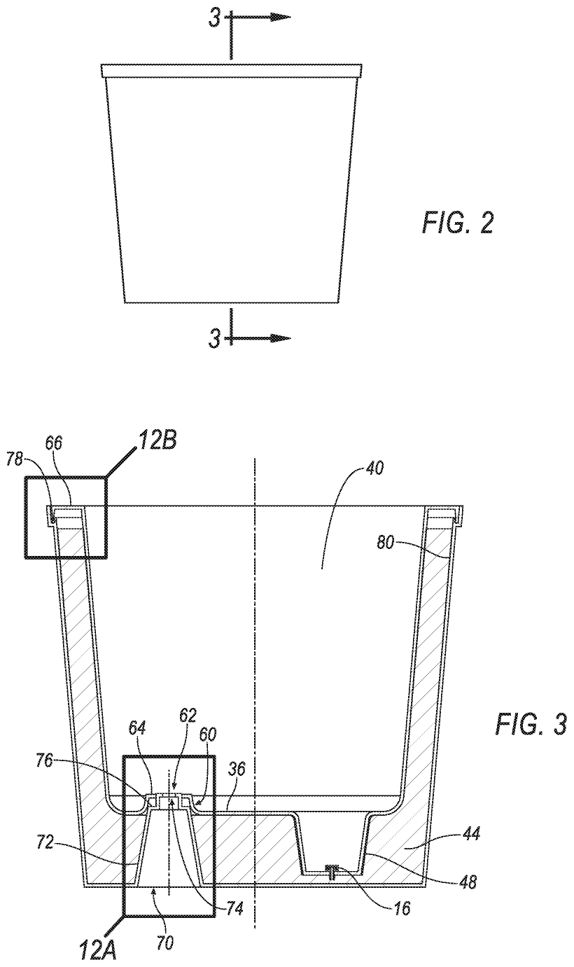

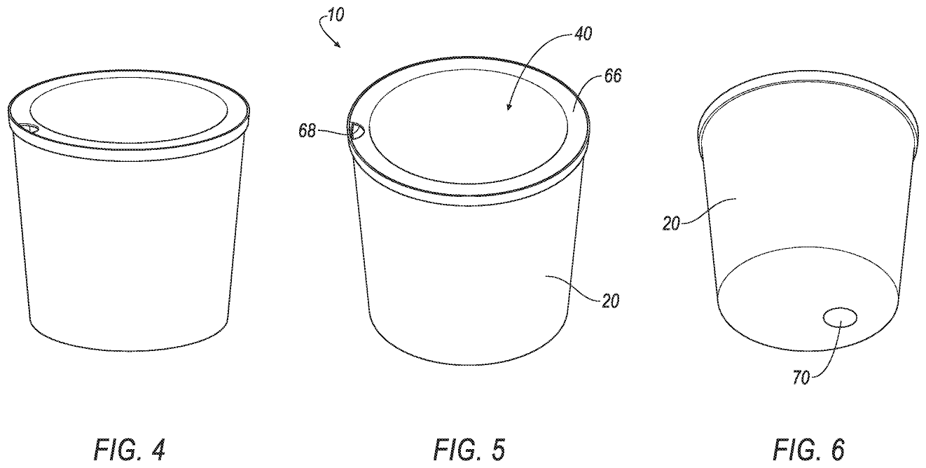

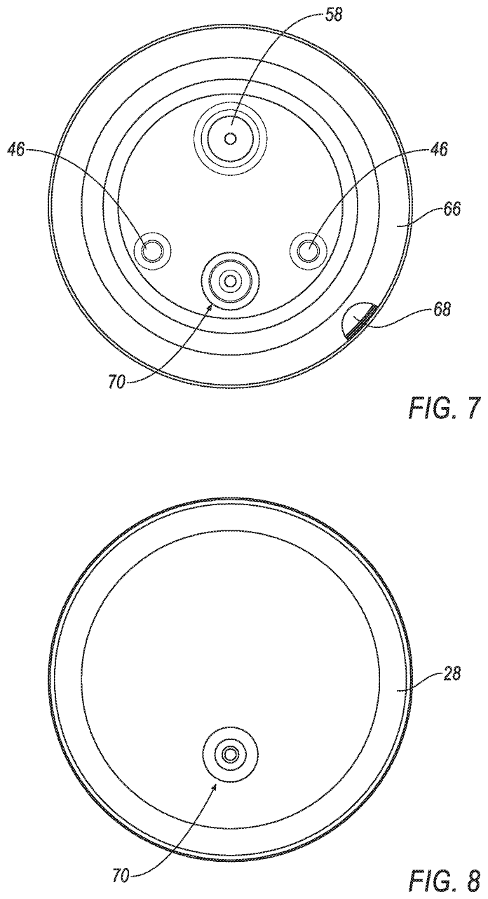

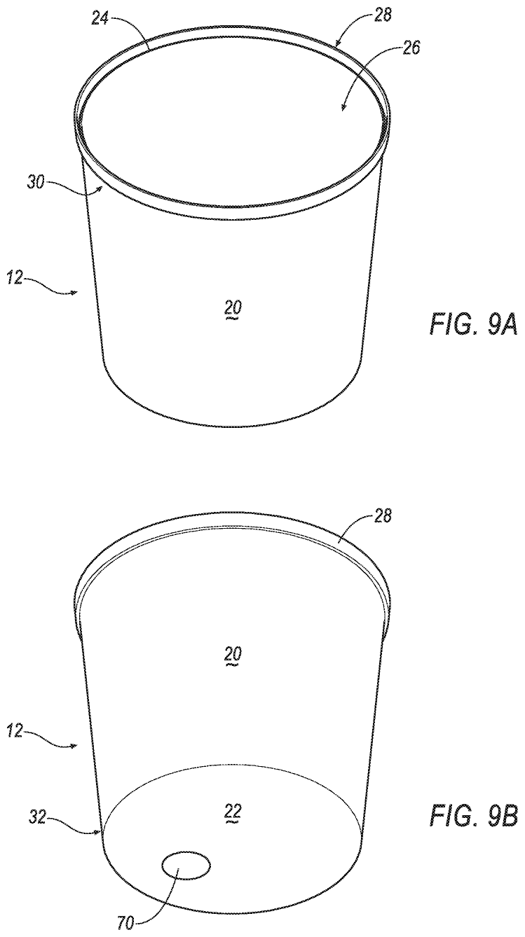

Referring to FIGS. 1-11, an exemplary arrangement of a planter 10 is illustrated. The planter 10 comprises an outer shell 12 and an inner shell 14, and a valve member 16. In one exemplary arrangement, optional moisture retention material 18 may also be provided. The outer shell 12 (best seen in FIGS. 9A-9B) is defined by a body section 20, a bottom surface 22 and an opening 24 that provides access to an interior 26 of the outer shell 12. A rim 28 encircling the opening 24 may also be provided. The body section 18 is defined by an upper end 30 and a lower end 32. The lower end 32 extends upwardly from the bottom surface 22. In one exemplary arrangement, the body section 20 is tapered from the upper end 30 to the lower end 32, such that the lower end 32 has a smaller cross-sectional area than the upper end 30.

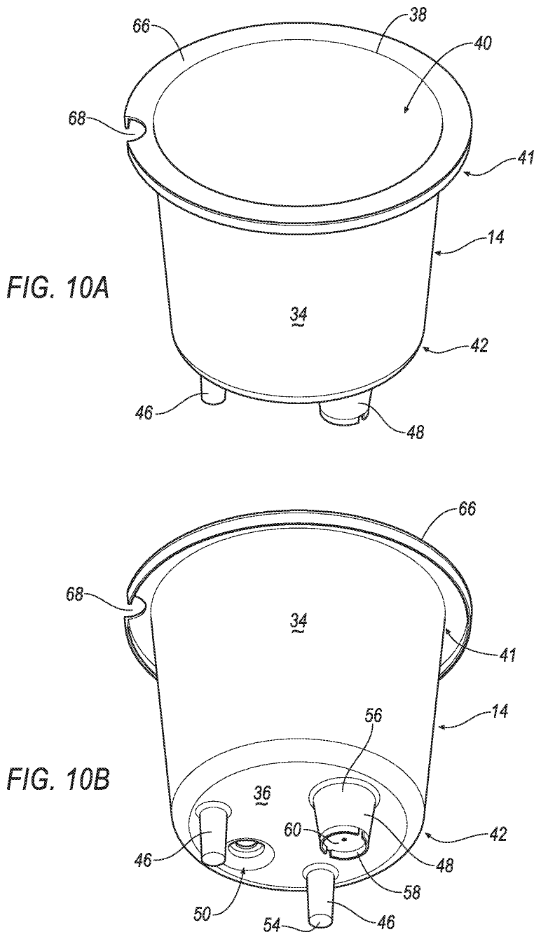

The inner shell 14 (best seen in FIGS. 10A-10B) is sized to be at least partially received within the interior 26 of the outer shell 12. The inner shell 14 is defined by a body section 34, a bottom surface 36 and a top opening 38 that provides access to an interior 40 of the inner shell 14. The body section 34 is defined by an upper end 41 and a lower end 42. In one exemplary arrangement, the body section 34 is tapered from the upper end 41 to the lower end 42, such that the lower end 42 has a smaller cross-sectional area than the upper end 41. The inner shell 14 is sized to be smaller than the outer shell 12 so as to form a hollow area 44 between the inner shell 14 and outer shell 12 when the inner shell 14 is disposed therein (best seen in FIG. 3), as will be discussed in further detail below.

In one exemplary arrangement, the body section 34 may include a plurality of perforations (not shown) that provide communication from the interior 40 of the inner shell 14 to the hollow area 44. In one exemplary arrangement, the perforations may be arranged into aligned rows that extend along a substantially linear line adjacent the bottom surface 34 and toward the upper end 41 of the body section 34. In one exemplary arrangement the perforations are arranged radially about a central axis A-A extending through the planter 10. However, it is understood that other arrangements of the perforations are contemplated and that the perforations are optional.

The bottom surface 36 of the inner shell 14 may include one or more downwardly extending pedestals 46, a water delivery member 48, and a bottom opening 50 (best seen in FIG. 10B). In one exemplary arrangement, the pedestals 48 are structured to contact the bottom surface 20 of the outer shell 12 to assist in maintaining the inner shell 14 in a substantially spaced relationship with the outer shell 12, when connected. More specifically, “substantially spaced” as used herein, means that a greater part of the surface area of the inner shell 14 and the outer shell 12 are not in contact with each other to provide the hollow area 44. In another arrangement, the pedestals 46 do not directly contact the bottom surface 20 of the outer shell 12.

In one exemplary arrangement, the pedestals 46 and water delivery member are spaced equi-distance from one another, about the central axis A of the planter 10. Each pedestal 46 may be unitary with the inner shell 14, and is defined by an open upper end 52 and a closed lower end 54. The pedestals 46 extend downwardly from the bottom surface 36 of the inner shell 14 such that the closed lower end 54 is spaced away from the bottom surface 36 of the inner shell 14. The pedestals 48 are generally hollow, with the open upper end 52 being in communication with the interior 40 of the inner shell 14. The pedestals 46 may taper from the upper end 50 to the lower end 52.

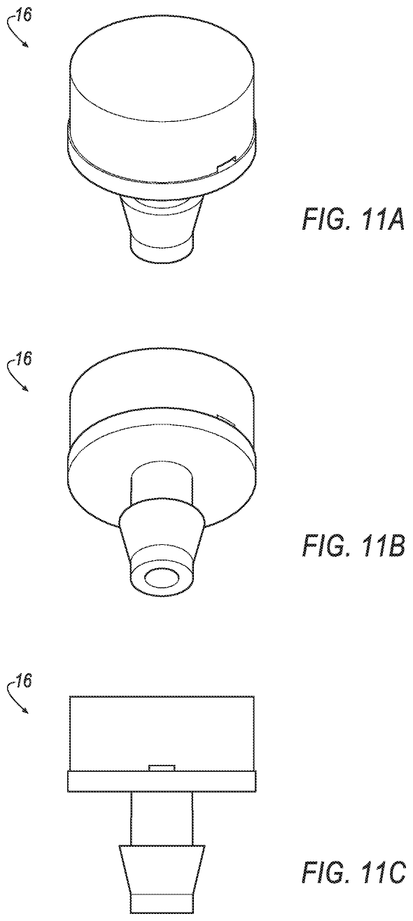

The water delivery member 48 may also be unitary with the inner shell 14 and extend downwardly from the bottom surface 36 of the inner shell 14, similar to pedestals 48. The water delivery member 48 is defined by an open upper end 56 and a substantially closed lower end 58. The lower end 58 further includes a valve opening 60 into which the valve member 16 is disposed. An exemplary valve member 16 is illustrated in FIGS. 11A-11C. In one exemplary arrangement, the water delivery member 48 has a length that is shorter than the length of the pedestals 48 such that the lower end 58 of the water delivery member 48 is spaced above the bottom surface 22 of the outer shell 12, when the inner shell 14 is disposed within the interior 26 of the outer shell 12, as best seen in FIG. 3.

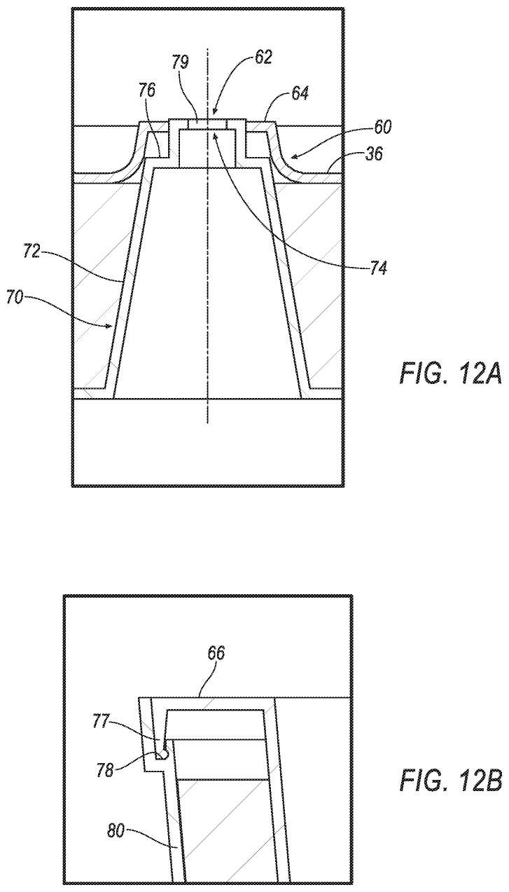

Circling the bottom opening 50 in the inner shell 14 is an upwardly extending mount 60 that includes an opening 62 therethrough. The mount 60 extends upwardly from the bottom surface 36 of the inner shell 14 and includes a flange member 64 disposed around the opening 62, as best seen in FIGS. 3 and 12A.

Surrounding the upper end 41 of the inner shell 14 is an outwardly extending flange 66. The flange 66 includes an opening 68 formed therein to provide access to the hollow area 44, as will be explained in greater detail below.

The outer shell 12 further includes an overflow element 70. In one exemplary arrangement, the overflow element 70 includes an upwardly extending wall member 72 and a stopper element 74. The stopper element 74 extends inwardly from an outer circumference of the wall member 72 such that a positioning shoulder 76 is formed. Referring to FIG. 12A, when the inner shell 14 is disposed within the outer shell 12, the stopper element 74 is disposed within a cavity formed by the mount 60 in the inner shell 14 and extends through the bottom opening 50. The stopper further includes an opening 79 therethrough. The opening 79 is sized to allow water to pass through, but prevent soil from exiting therethrough.

The planter 10 is assembled as follows. The valve 16 is disposed within the opening 60 formed in the water delivery element 58 of the inner shell 14. The inner shell 14 is disposed within the interior 26 of the outer shell 12. The pedestals 46 are disposed against the bottom surface 22 of the outer shell 12, with the overflow element 70 being aligned with the opening 50 formed within the bottom surface 36 of the inner shell 14 and the stopper 76 being received within the mount 60. The flange 66 of the inner shell 14 includes a downwardly extending mount element 77 that engages a mounting edge 78 formed on an inside surface 80 of the outer shell 12, adjacent the upper end 30 as shown in FIGS. 3 and 12B. The inner shell 14 may be sealed to the outer shell 12 to secure the inner shell 14 to the outer shell 12 together, using any suitable method. Because the opening 68 is formed through the flange 66, access is provided to the hollow area 44.

In the alternative embodiment where the moisture retention material 18 is provided, the moisture retention material 18 may be disposed within the outer shell 12 prior to the inner shell 14 being positioned within the interior 26 of the outer shell 12 such that the moisture retention material 16 is compressed within the hollow area 44 formed by the inner surface of the outer shell 12 and the outer surface of the inner shell 14. In one exemplary arrangement, the moisture retention material 16 is rock wool (also known as mineral wool). Rock wool is comprised of spun fiber strands formed from rock that are compressed into a dense mat-like material. The rock wool is pliable, but also allowing for a friction fit between the inner and outer shells 14, 12.

In use, once the outer and inner shells 12, 14 are assembled, a plant may be planted within soil within the interior 40 of the inner shell 14. Water may be introduced to the hollow area 44 via the opening 68. Water may be stored within the hollow area 44 and delivered via the water delivery element 58, through the valve 16. For the embodiments where there are apertures formed through the body element 34 of the inner shell 14, water may flow through the apertures from the hollow area 44 and into the interior 40. For those embodiments that incorporate rock wool, the water will be retained and stored until needed by the plantings. The valve 16 also allows for water to be metered into the soil. In the event water is introduced into the interior 40 directly and too much water is present in the soil, the overflow element 70 is provided. Water can exit the interior 40 through the opening 79 and exit the planter 10 through the bottom of the overflow element 70.

It will be appreciated that the planter arrangement described herein and methods described herein have broad applications. The foregoing embodiments were chosen and described in order to illustrate principles of the apparatuses as well as some practical applications. The preceding description enables others skilled in the art to utilize apparatuses in various embodiments and with various modifications as are suited to the particular use contemplated. In accordance with the provisions of the patent statutes, the principles and modes of operation of this disclosure have been explained and illustrated in exemplary embodiments.

It is intended that the scope of the present methods and apparatuses be defined by the following claims. However, it must be understood that this disclosure may be practiced otherwise than is specifically explained and illustrated without departing from its spirit or scope. It should be understood by those skilled in the art that various alternatives to the embodiments described herein may be employed in practicing the claims without departing from the spirit and scope as defined in the following claims. The scope of the disclosure should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future examples. Furthermore, all terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary. It is intended that the following claims define the scope of the invention and that the method and apparatus within the scope of these claims and their equivalents be covered thereby. In sum, it should be understood that the invention is capable of modification and variation and is limited only by the following claims.

What is claimed is:

1. A self-watering planter, comprising:
an outer shell defined by a bottom surface, a body section and a top opening providing access to an interior;
an inner shell defined by a bottom surface, a body section and a top opening providing access to an interior, the inner shell being sized to be smaller than the interior of the outer shell;
the inner shell further comprising a water delivery device having a valve element therein;
wherein the inner shell is disposed within the interior of the outer shell such that a hollow area is formed between the outer surface of the inner shell and the inner surface of the outer shell for retaining water;
wherein an opening is formed through a rim of the planter to provide access to the hollow area for water to be received;
wherein water is metered into the interior of the inner shell by the valve element.

2. The self-watering planter of claim 1, wherein the inner shell further includes one or more pedestals extending downwardly from the bottom surface of the inner shell, the pedestals configured for engaging the bottom surface of the outer shell to space the inner shell from the outer shell to create the hollow area for water.

3. The self-watering planter of claim 2, wherein the water delivery device extends downwardly from the bottom surface of the inner shell and is defined by an open upper end and a substantially closed lower end that further includes a valve opening into which the valve member is disposed.

4. The self-watering planter of claim 2, wherein the water deliver member has a length that is shorter than a length of the pedestals such that a lower end of the water delivery member is spaced above the bottom surface of the outer shell when the inner shell is disposed within the interior of the outer shell.

5. The self-watering planter of claim 1, further comprising an overflow element partially defined by a portion of the outer shell.

6. The self-watering planter of claim 5, wherein the overflow element further comprises a wall member extending upwardly from a bottom surface of the outer shell and a stopper element extending inwardly from an outer circumference of the wall member to define a positioning shoulder, wherein the stopper element has an opening therethrough.

7. The self-watering planter of claim 6, wherein the inner shell includes a bottom opening in the bottom surface of the inner shell, and wherein the stopper element is disposed within the bottom opening and the opening in the stopper element provide egress for water from the interior of the inner shell externally from the planter.

8. The self-watering planter of claim 7, further comprising an upwardly extending mount disposed about the opening formed through the bottom surface of the inner shell.

9. The self-watering planter of claim 1, wherein the rim is defined by an outwardly extending flange disposed around the upper end of the inner shell and the opening that provides access to the hollow area is formed in the flange.

10. The self-watering planter of claim 9, wherein the flange includes a downwardly extending mount element, the mount element engaging a mounting edge formed on an inside surface of the outer shell.

11. The self-watering planter of claim 1, further comprising water retaining material disposed in the hollow area.

12. A self-watering planter, comprising:
an outer shell defined by a bottom surface, a body section and a top opening providing access to an interior, the bottom surface of the outer shell partially defining an overflow element;
an inner shell defined by a bottom surface, a body section and a top opening providing access to an interior, the inner shell being sized to be smaller than the interior of the outer shell;
the inner shell further comprising a water delivery device having a valve element therein;
wherein the inner shell is disposed within the interior of the outer shell such that a hollow area is formed between the outer surface of the inner shell and the inner surface of the outer shell for retaining water;
wherein an opening is formed through a rim of the planter to provide access to the hollow area for water to be received;
wherein the overflow element comprises a wall member extending upwardly from a bottom surface of the outer shell and a stopper element extending inwardly from an outer circumference of the wall member to define a positioning shoulder, wherein the stopper element has an opening therethrough;
wherein water is metered into the interior of the inner shell by the valve element; and wherein the overflow element allows egress of water from the interior of the inner shell out of the planter.

13. The self-watering planter of claim 12, wherein the water delivery device extends downwardly from the bottom surface of the inner shell and is defined by an open upper end and a substantially closed lower end that further includes a valve opening into which the valve member is disposed.

14. The self-watering planter of claim 13, wherein the water deliver member has a predefined length such that a lower end of the water delivery member is spaced above the bottom surface of the outer shell when the inner shell is disposed within the interior of the outer shell.

15. The self-watering planter of claim 12, wherein the rim is defined by an outwardly extending flange disposed around the upper end of the inner shell and the opening that provides access to the hollow area is formed in the flange.

16. The self-watering planter of claim 15, wherein the flange includes a downwardly extending mount element, the mount element engaging a mounting edge formed on an inside surface of the outer shell.

17. The self-watering planter of claim 12, further comprising water retaining material disposed in the hollow area.

18. The self-watering planter of claim 17, further comprising openings formed through the body section of the inner shell.

19. The self-watering planter of claim 12, wherein the inner shell includes a bottom opening in the bottom surface of the inner shell and an upwardly extending mount disposed about the opening formed through the bottom surface of the inner shell, and wherein the stopper element is disposed within the bottom opening and the opening in the stopper element provide egress for water from the interior of the inner shell externally from the planter.

20. A self-watering planter, comprising:
an outer shell defined by a bottom surface, a body section and a top opening providing access to an interior, the bottom surface of the outer shell partially defining an overflow element;
an inner shell defined by a bottom surface, a body section and a top opening providing access to an interior, the inner shell being sized to be smaller than the interior of the outer shell;
the inner shell further comprising a water delivery device having a valve element therein and wherein the inner shell includes a bottom opening in the bottom surface of the inner shell and an upwardly extending mount disposed about the opening formed through the bottom surface of the inner shell;
wherein the inner shell is disposed within the interior of the outer shell such that a hollow area is formed between the outer surface of the inner shell and the inner surface of the outer shell for retaining water;
wherein an opening is formed through a rim of the planter to provide access to the hollow area for water to be received, wherein the rim is defined by an outwardly extending flange disposed around the upper end of the inner shell and the opening that provides access to the hollow area is formed in the flange;
wherein the overflow element comprises a wall member extending upwardly from a bottom surface of the outer shell and a stopper element extending inwardly from an outer circumference of the wall member to define a positioning shoulder, wherein the stopper element has an opening therethrough, wherein the stopper extends through the opening formed through the opening disposed on the bottom surface of the inner shell; and
wherein water is metered into the interior of the inner shell by the valve element; and wherein the overflow element allows egress of water from the interior of the inner shell out of the planter.
